(19) United States
(12) Patent Application Publication
(10) Pub. No.: US 2026/0194296 A1
(43) Pub. Date: Jul. 9, 2026

(54) TREATMENT PLANT FOR TREATING WORKPIECES, AND METHOD FOR TREATING WORKPIECES

(71) Applicant: Dürr Systems AG, Stuttgart (DE)

(72) Inventors: Oliver Iglauer-Angrik, Stuttgart (DE); David Carl, Lauffen am Neckar (DE); Kevin Woll, Heilbronn (DE); Dietmar Wieland, Waiblingen (DE); Gerhard Steurer, Röhrmoos (DE); Jens Goetze, Seerhausen (DE); Adrian Bamler, Regensburg (DE)

(21) Appl. No.: 19/130,863

(22) PCT Filed: Nov. 20, 2023
(86) PCT No.: PCT/DE2023/100899

§ 371 Date: May 16, 2025

(30) Foreign Application Priority Data
Nov. 29, 2022 (DE) 10 2022 131 532.0

(51) Int. Cl. F26B 21/20; F26B 23/00; F26B 23/04; F26B 23/10

(52) U.S. Cl. CPC F26B 21/20; F26B 23/002; F26B 23/04; F26B 23/10; F26B 2210/12

(57) ABSTRACT

The present invention relates to a treatment plant (100) for treating workpieces, in particular a drying plant (102) for drying vehicle bodies, comprising: at least one treatment chamber (104), which comprises one or more treatment chamber sections (105), wherein the at least one treatment chamber (104) and/or the one or more treatment chamber sections (105) are each assigned to one of a plurality of separate air circulation modules (106), and wherein each air circulation module (106) is arranged to carry a separate cyclical gas flow; and a heat carrier system (120) for indirectly heating the gas flows, which comprises a heating device (124), wherein a) at least one air circulation module (106) has a heat exchanger (144), by means of which the respective air circulation module (106) is coupled to the heat carrier system (120); and/or b) a plurality of air circulation modules (106) is incorporated into one or more heating circuits (160), in particular heating gas circuits, which are coupled to the heat carrier system (120) via a central heat exchanger (158). The present invention further relates to a method for treating workpieces.

### RELATED APPLICATIONS

This application is a national phase of international application No. PCT/DE2023/100899 filed on Nov. 20, 2023, and claims the benefit of German application No. 10 2022 131 532.0 filed on Nov. 29, 2022, which are incorporated herein by reference in their entirety and for all purposes.

### FIELD OF DISCLOSURE

The disclosure relates to a treatment plant for treating workpieces. The disclosure further relates to a method for treating workpieces.

### BACKGROUND

It is known from practical experience that, in combating global warming, more and more motor vehicle manufacturers are considering converting existing treatment plants, such as drying plants for vehicle bodies, from the use of fossil fuels such as gas, oil etc. to heating by means of electric energy from renewable sources of energy.

It is known that the prevailing method in heating such drying plants or dryers has hitherto been a combination of heat supply and exhaust air purification, wherein the residual heat still present in the purified dryer exhaust air or the clean gas is transferred with the aid of heat exchangers—usually connected in series—to the dryer atmosphere, i.e. the circulating air and/or the fresh gas or fresh air, without mixing the two media in the process.

In switching or converting a drying plant from fossil-fuel to electric heating, it is customary to have recourse to decentralized electric heat sources for heating the air circulation and fresh air modules, also referred to as air circulation and fresh air units, and thus to exploit the possibilities of electric direct heating, for which purpose each air circulation and fresh air module is generally equipped with a dedicated heating element.

A direct heating system converts electric energy into heat energy or heat in that the electric current flows through a heating spiral, a heating wire or the like subject to resistance. Via heat conductors—e.g. heating fins—the heat energy is released directly to the gas flow to be temperature-controlled, e.g. the circulating air flow or the fresh air flow.

The dryer exhaust air is purified independently of the dryer heating. Usually, thermal methods are used to purify the exhaust air, which contains solvents and has an unpleasant smell.

As part of electrification, these purification processes are then likewise brought to the operating temperature by means of electric energy. As soon as the system reaches the required operating temperature, it is often the case—depending on the solvent burden or load—that only the heat energy released by the oxidation of solvents is required to achieve self-sustaining and autothermal operation of the exhaust air purification device.

However, the specification of and adaptation to the decentralized electric heating elements in the individual air circulation and fresh air modules has the effect that, for dryer heating, heat sources with sustainable energy carriers such as hydrogen, biogas, solar energy, pellets etc. are not exchangeable. Parallel reservation or parallel use of several different heat sources in what is referred to as a hybrid operating mode is also not possible with a decentralized electric direct heating system.

The parallel use or at least reservation of several possibilities is a decisive advantage, precisely in the energy transition era, especially since many operators of drying plants or similar plants are entirely unable at the present time to foresee what form of energy will be the energy of the future for their site.

Moreover, the concept of a dryer heating system with decentralized electric heat sources such as heating elements entails a large surface area requirement. Switch cabinets with the required power control (e.g. thyristors) of the individual heating elements must be set up.

In addition, there is the setting up of transformer load-center substations to supply power to the individual heat sources. Since voltage conversion from the medium voltage level (with small cable cross sections) to the low voltage level ideally takes place where the electric energy is required, i.e. at the decentralized heat sources, there arises a need for setup areas, which are often impossible to service in existing plants owing to the constrained situation as regards buildings. If it is not possible to set up the load-center substations close to the loads, i.e. the heat sources, large and expensive cable cross sections are required at the low voltage level in order to avoid high power losses.

In addition, the previous concept of a dryer heating system with decentralized electric heating elements requires a high outlay on power cabling since each unit or each element must be connected individually.

In this context, the associated power losses (line and switch cabinet losses), which, in the case of a drying plant for vehicle bodies with an illustrative throughput of 31 units per hour, may add up to 173 KW and thus about 11% of the total power, cannot go unmentioned. These high electrical losses are in conflict with the original sustainability concept underlying conversion. Although these line losses can be partially countered by cable cross sections of larger dimensions, this is associated with higher investment costs.

Another disadvantageous aspect is that the sum of the connected loads of the individual electric heat sources or heating elements is generally greater (by about 10%) than in the case of a centralized solution with just a single heating source.

In the case of a single heating source, the power requirement of a dryer or drying plant, which, with a warm-up time of just two to three hours in the case of operation or production, is virtually indistinguishable from the warm-up case, can be covered by this single heating source in both operating modes.

In comparison with this, however, there are considerable differences between the two modes of “warm-up” and “operation or holding” at the section or zone level, i.e. in the case of separate heating of individual sections or zones of the dryer. Thus, with warm-up sections, the power requirement in the case of operation is generally higher than in the warm-up case, and the situation is exactly the reverse with holding sections.

Consequently, with a decentralized electric solution, the electric heating elements must be dimensioned according to whether the operating case or the warm-up case has the higher heating power, since each dryer section has to be heated independently and must therefore also be considered separately as regards energy.

EP 3 387 354 A1 has already disclosed that, to provide a treatment plant which is of simple construction and allows energy-efficient workpiece treatment, the treatment plant comprises a treatment chamber which comprises a plurality of treatment chamber sections, each of which is assigned one of several separate air circulation modules of the treatment plant. The treatment plant furthermore comprises a heating system which comprises a self-contained heating gas duct, wherein a plurality of air circulation modules is coupled to the heating gas duct, in particular in order to heat the gas passed through the treatment chamber sections.

It is therefore the underlying object of examples disclosed herein to provide a treatment plant which enables sustainable operation.

### SUMMARY

According to examples disclosed herein, this object is achieved by means of a treatment plant having the features according to claim 1.

The treatment plant is, in particular, a drying plant for drying vehicle bodies.

The treatment plant comprises the following:
at least one treatment chamber, which comprises one or more treatment chamber sections, wherein the at least one treatment chamber and/or the one or more treatment chamber sections are each assigned to one of a plurality of separate air circulation modules, and wherein each air circulation module is arranged to carry a separate cyclical gas flow; and
a heat carrier system for indirectly heating the gas flows, which comprises a heating device,
   wherein it is optionally possible to provide that
a) at least one air circulation module has a heat exchanger, by means of which the respective air circulation module is coupled to the heat carrier system; and/or
b) a plurality of air circulation modules is incorporated into one or more heating circuits, in particular heating gas circuits, which are coupled to the heat carrier system via a central heat exchanger.

Examples disclosed herein are based on the concept that, particularly in the case of conversion of existing plants, there is the possibility, in addition to heating by means of electric energy from renewable energy sources, of using additional sustainable energy carriers. Moreover, conversion should also be possible in the case of plants in which there are no free setup areas available in the region of the treatment plant, in particular in the region of the drying plant. The overall concept of the plant should take account of the concept of sustainability and energy saving by as far as possible minimizing power losses, in particular.

Overall, it is advantageous to decouple the treatment plant hydraulically into a primary and a secondary circuit by means of a hydraulic switch in order to ensure hydraulically independent operation of the heater circuit, i.e. the circuit of the heat carrier system, and the load circuit, i.e. the circuit of the air circulation modules, and to enable multiple feeding of the heat carrier medium into the heater circuit, preferably from various heat sources.

It should be understood that the central heat exchanger can be coupled to one or more heating gas circuits, into each of which one or more air circulation modules can be incorporated.

It is advantageous if the heat carrier system comprises:
a closed heat carrier circuit, which has at least one feed and at least one return and in which a heat carrier medium, in particular a liquid heat carrier medium, circulates.

It is conceivable that the heating circuit carries a heating gas or some other heat carrier medium to which heat energy has been transferred from the heat carrier system. In the case of a heating gas circuit, this is added directly to the gas flows circulating in the air circulation modules, whereas, in the case of some other heat carrier medium, there is preferably merely transfer of the heat energy to the gas flows of the air circulation modules without the corresponding medium getting into these gas flows.

The heating device is preferably set up centrally (e.g. at a location not at risk of explosions), and the heat is fed via a branching pipe network to individual loads, such as air circulation and/or fresh gas modules, by means of the heat carrier medium or by means of the heating gas.

The heat carrier medium can be solid, liquid or gaseous.

A solid heat carrier medium can comprise balls which are filled with a phase change material, whereas, for safety reasons, a gaseous heat carrier medium can preferably be in the form of vapor.

A liquid heat carrier medium is, in particular, a thermal oil, water or an ionic liquid, wherein, for example, the thermal oil is unpressurized and thus easier to handle or deliver in the heat carrier system than vapor.

Where thermal oil is used as the heat carrier medium, the feed temperature is preferably 250° C. and the return temperature is preferably 230° C.

The aim is a thermal oil temperature which is as low as possible in order to avoid the formation of low-boiling fractions (decomposition of the hydrocarbon chains into smaller fragments). Such decomposition results in a lowering of the flash point and, on the one hand, increases the risk of the formation of an inflammable mixture and, on the other hand, the tendency for cavitation, which can lead to increased wear on plant components (e.g. pumps). If, therefore, reaching of the “film temperature” of the thermal oil is avoided, the longevity of the oil is promoted or at least maintained.

With the preferred temperature range, which is very low for thermal oil, it is possible to take account of the known Arrhenius law, according to which the reaction rate rises exponentially with temperature, and thus the risk to safety and to the life of plant components is kept very low.

On the other hand, the thermal oil temperature is sufficient to bring even supplied fresh gas, such as fresh air from the treatment plant shop and from outside the plant building, to the required target temperature. In general, this is 10 to 20 K above the circulating air temperature in the treatment chamber.

Another important aspect should be mentioned in respect of the thermal oil temperatures. Owing to the moderate temperature selected, these are still in the range of mineral oils. Higher temperatures, on the other hand, would require silicone-based or synthetic oil. However, these often have the disadvantage that they contain substances that interfere with paint wetting and must therefore not be used in a treatment plant such as a paint shop.

Moreover, a mineral oil must generally be assigned to water hazard class 1, and therefore no additional precautionary measures are required. In addition, unpressurized operation is possible in the case of a thermal oil temperature in the range of from 230° C. to 250° C. Only the pressure difference for forced circulation of the thermal oil in the distribution network, i.e. in the heat carrier circuit, must be applied by a pump device.

In comparison with air, thermal oil furthermore has a higher specific heat capacity and a higher density, thereby making it possible to significantly reduce the pipe cross sections of the heat carrier circuit in comparison with hot air ducts. Significantly smaller pipe cross sections likewise mean significantly lower surface heat losses. Integration into existing plants is thus easier.

Moreover, provision can be made for the heating device to comprise at least one, preferably at least two, different heat sources, wherein the heat source is designed as
a) an electric heating element, and/or
b) a gas-fired heating boiler, and/or
c) a hydrogen-fired heating boiler, and/or
d) a solar-thermal additional heater, and/or
e) a heating gas circuit.

In the gas-fired heating boiler, it is possible, for example, to use, that is to say, in particular, to burn, carbonized hydrogen, natural gas, biogas or methane.

The central setup of the heating device results, in particular, in the advantage over the decentralized heating mentioned at the outset that one heat source can easily be substituted or else that several different heat sources can be held in readiness in parallel. This possibility is of advantage precisely in the energy transition era since many operators are entirely unable at the present time to foresee what form of energy will be the energy of the future for their site. Moreover, the central setup enables easy successive expansion of the heating device.

In the case of the electric heating element, the following types of power come into consideration:

### AC Low Voltage (400 kV)

The advantage is simple low voltage technology on the heater side of the heating device, this being associated with low investment costs. However, there are higher cable power losses in comparison with medium voltage, although these can be minimized by setting up the corresponding heat source in the vicinity of a transformer load-center substation and thus enabling the cable lengths to be kept as short as possible. Moreover, the transforming of the works voltage or plant voltage to a low voltage level is associated with not inconsiderable investment costs.

### AC Medium Voltage (1 to 35 kV)

The advantage is that relatively small cable cross sections and relatively low cable power losses can be achieved in comparison with low voltage. In addition, there may be a saving if it is possible to avoid setting up the load-center substation in the immediate vicinity of the heating device and, as a result, the lower costs for the cabling and the transformer load-center substation more than make up for the other costs (e.g. additional costs on the heater side). Moreover, the expenditure on a transformer is reduced, or it is possible to eliminate the transformer load-center substation, if the electric heating element can be operated directly at the medium voltage level of the plant network. In comparison with low voltage, however, a more complex medium voltage system is required on the heater side, with corresponding costs.

### Direct Current

The possibilities for industrial DC energy distribution are many and various. By means of a DC distribution network or grid, it is possible, for example, to incorporate photovoltaic modules or decentralized energy storage devices easily into the existing infrastructure. The direct current from photovoltaic modules is, for example, transferred directly to installed heating bars and converted directly and without losses into heat. The associated reduction in losses during the conversion of AC to DC, and also intelligent load management, can significantly reduce energy consumption and avoid peak loads. This, in turn, has a positive effect on equipment designs and installations and on a more favorable power tariff. Moreover, the integration of photovoltaic modules and storage systems enhances the reliability of supply.

The gas-fired heating boiler is preferably used to enable the installation of unnecessary electric power to be eliminated in the case of an increased power requirement for warming up the cold treatment plant over and above the required production or operating power, since the power difference relative to the electrically generated operating power is supplied by means of the gas-fired heating boiler.

In the case of thermal oil feed temperatures of about 250° C. to 300° C., it is possible, at sunny locations with a high direct solar contribution, to draw upon concentrating solar-thermal technology as additional solar-thermal heating for plant heating. Fresnel collectors installed on the roof of the treatment plant can be incorporated into the thermal oil circuit either directly or by means of a heat exchanger. The first approach, that of direct incorporation, would have the advantage that the thermal oil circuit already provided could be used for the solar-thermal process.

Depending on the different embodiments of the treatment plant, the heating device can be operated by means of pure hydrogen heating or in a hybrid mode of operation.

In the case of the hybrid mode of operation, the installed electric power is preferably reduced by a hydrogen-assisted warm-up mode of the treatment plant, and, in this case, the requirement for hydrogen can be covered by means of a hydrogen tank.

Hydrogen heating offers the possibility of CO₂-neutral operation of the plant.

One crucial challenge in using hydrogen is the management of the fire and explosion risk, which requires adequate protective measures, with the risk of an explosion on the release of hydrogen in interior spaces being increased. Moreover, leaks are difficult to detect without special detectors. In addition, there may be embrittlement of materials due to the diffusion of hydrogen if corresponding materials are used.

To allow for these safety aspects as effectively as possible, it is advantageous to position the hydrogen-fired heating boiler or the hydrogen-fired central heater unit outside the building in a well-ventilated location (e.g. in the open air). In that case, even safety regulations that are issued in future will only affect the setup of the central heater unit and it will be possible to implement them with correspondingly lower expenditure than in the case of indoor installation.

In the event that the hydrogen-fired heating boiler is to be or must be operated inside the plant or inside a building, the pipes will be of welded construction and therefore be, technically, permanently leakproof. During this process, a certain number of weld seams will be x-rayed at regular intervals, and all threaded and flanged joints must be checked at regular intervals. It is recommended that hydrogen detection should be implemented by means of one or more sensors and that they should be connected to a gas warning system, thereby making it possible, for example, in the event of an alarm, for solenoid valves to shut down or shut off corresponding zones or sections.

An outdoor setup is made possible by the fact that the generated heat energy of the hydrogen-fired heating boiler or of the hydrogen-fired central heater unit is transferred to the heating gas circuit via the heat carrier circuit and the central heat exchanger, wherein the central heat exchanger is preferably arranged inside the building or the shop of the treatment plant.

For heat distribution in the region of the treatment plant, the heating gas circuit mentioned with a gaseous heat carrier medium is suitable, wherein in this case the heat supply to the air circulation modules is achieved by admixing the heating gas. Accordingly, no heat exchangers are required in the air circulation modules in the embodiment of the treatment plant with a heating gas circuit, these being replaced by so-called admixture flaps for open-loop and/or closed-loop control of the heating gas volume flow fed in. The return of the heating gas circuit to the central heat exchanger can also be embodied as a simple return duct; preferably inside the treatment chamber or dryer tunnel (“triangular duct” in the rear wall/ceiling area), as a result of which there are virtually no surface heat losses.

The central heat exchanger is preferably positioned close to the treatment plant. This entails a reduced risk of plant contamination with thermal oil and, as a result, a significantly reduced fire load. In other words, setting up the central heat exchanger at the treatment plant means that fewer pipes have to be provided or that shorter pipes can be laid, thereby reducing the overall circulating volume of thermal oil and thereby also reducing the fire load in the event of an accident.

It is furthermore advantageous if
a) the at least one heat source is exchangeable with another heat source; and/or
b) at least two different heat sources can be operated in parallel and/or in alternation.

“Exchange” should be taken to mean that the operator of the treatment plant can easily exchange the previously used heat source with a heat source of some other type in response to a changed supply situation.

As an alternative or in addition, the heating device can already have two or more different heat sources in reserve, thus enabling the different heat sources to be operated in parallel or alternately, i.e. in alternation with one another, in the manner of a hybrid heating system, depending on the supply situation or the available reserve.

It is advantageous if the heating device comprises at least one expansion tank for compensating a thermally induced change in the volume of the heat carrier medium.

The heat carrier medium, such as the thermal oil, can expand freely via a non-closable expansion line between the heat source and the expansion tank or expansion vessel. Nitrogen blanketing in the expansion tank ensures the required pressure compensation and sealing with respect to a supply of oxygen to ensure that the oil does not oxidize.

In addition, the following measures may be mentioned as safety measures, in particular in relation to the use of thermal oil or hydrogen as a heat carrier medium:
monitoring of the volume flow, inter alia as defined in DIN 4754 Parts 1 to 3;
level switch in the expansion tank and/or deficiency protection system on the heating boiler to ensure that the plant cannot be run “dry”;
monitoring of the feed temperature (maximum permissible temperature of the thermal oil);
monitoring of the maximum permissible flue gas temperature (oil- or gas-fired boiler); and
monitoring of the minimum nitrogen pressure and/or monitoring of the pressure of the heat carrier system by means of minimum pressure limiters.

The aim, on the one hand, is an exhaust gas temperature which is as low as possible, this being achieved inter alia by means of a heat exchanger downstream of the exhaust gas purification device, which cools the exhaust gas discharged from the treatment plant further in order to exploit the condensing effect.

Furthermore, the boilers preferably require a minimum exhaust gas temperature in order to avoid condensate phenomena.

In another embodiment of examples disclosed herein, provision can be made for the heating gas circuit, the heat of which can be transferred to the heat carrier circuit by means of at least one heat exchanger comprises the following:
at least one electric heating device for heating the heating gas,
at least one mixing device, which is arranged downstream of the at least one electric heating device, and
at least one heat storage unit for storing and releasing heat,
   wherein the at least one heat storage unit is fluidically operatively connected to the at least one mixing device.

In the heating gas circuit, the heating gas is produced by the at least one electric heating device and its heat is either stored in the at least one heat storage unit or transferred by means of the at least one heat exchanger to the heat carrier circuit. The heat stored in the at least one heat storage unit can be released when required and fed to the heating gas. The storage and release of the heat in the at least one heat storage unit or from the latter is accomplished via the at least one mixing device.

The temporary storage of the heat in the at least one heat storage unit of the heating circuit is preferably accomplished by storing the heat during the weekend or during pauses in production. In this way, the stored heat can be drawn off in parallel with the heat provided or generated by the electric heating device when the treatment plant has to be heated to operating temperature or when more heat is required during production peaks.

Preferably, several heat storage units form a heat storage device, wherein it is advantageous if heat can be added to or discharged from the heat storage units individually.

The additional provision of heat from the at least one heat storage unit or from the heat storage device advantageously enables the achievement of quicker warm-up rates in comparison with a plant which has only an electric heating device. By means of a heat storage device it is furthermore possible to reduce the installed power of the electric heating device and thus the required connected load of the treatment plant. Moreover, the heating gas circuit with a heat storage device makes it possible to increase the flexibility of power procurement, thus making it possible to exploit power price fluctuations dependent on the time of day.

In another embodiment of examples disclosed herein, it is envisaged that the mixing device is configured in such a way that heating gas heated in the electric heating device
can be fed to the heat exchanger, or
at least some of the heat contained in the heating gas can be fed to the at least one heat storage unit for storage, or
can be fed to the heat exchanger with the admixture of at least some of the heat stored in the at least one heat storage unit.

Thus, the mixing device advantageously has at least three switching positions, by means of which the heating gas flow can preferably be directed.

The heat generated from electric energy in the at least one heating device is preferably stored in the at least one heat storage unit at times when the power price is low and, conversely, is released when power prices are high. It is therefore advantageous if the control-system variable in this context is the power price. Storing heat generated from electric energy would also make it possible to respond to a shortage of power or to a power outage.

The heat exchanger is preferably a gas-liquid heat exchanger, wherein to safeguard against liquid or heat carrier medium from being entrained out of the heat carrier circuit into the heating gas circuit, the heat exchanger preferably has a double wall and a liquid detection device between the inner and the outer tube.

In another embodiment of examples disclosed herein, provision can be made for the heat carrier system to comprise a pump device comprising at least one pump for delivering the heat carrier medium through the heat carrier circuit and at least part of the heating device.

The at least one pump can be a circulating pump, for example. It is furthermore conceivable for two or more pumps to be operated in parallel.

Provision can furthermore be made to provide a hydraulic switch between the at least one treatment chamber and the heat carrier system, by means of which switch the load circuit, which supplies the treatment chamber sections via the air circulation modules, is hydraulically decoupled from the heater circuit, i.e. the circuit of the heat carrier system.

In another embodiment of examples disclosed herein, provision can be made for the treatment plant to comprise an exhaust gas purification device, in particular an electric-thermal exhaust gas purification device, for purifying exhaust air, which can be fed from the treatment chamber, via an exhaust gas duct, to the exhaust gas purification device, wherein the exhaust gas purification device carries clean gas obtained by purification out of the treatment plant via a clean gas duct.

It should be understood that an electric thermal exhaust gas purification device is preferably an exhaust gas purification device which likewise uses electric energy from renewable energy sources.

Purifying the exhaust air from the treatment plant is preferably performed separately from heating.

In this context, catalytic afterburning is a known exhaust gas purification method. This method is also known as catalytic oxidation and is preferably used to reduce hydrocarbon emissions. The advantage over thermal afterburning resides in the lower reaction temperature. A reaction temperature of about 790° C. is required to ensure that the exhaust air is adequately purified, wherein this temperature is substantially independent of whether an RTO or a thermal afterburning system is used. However, it should be noted that certain ingredients of paint can act as catalyst poisons and will clog the catalytic converter. Accordingly, the maintenance requirement for the plant and the risk of outages may be high.

A thermal method for purifying the exhaust air, which contains solvents and has an unpleasant smell, is therefore to be preferred. In particular, a thermal method enables autothermal operation by means of the released heat energy due to the oxidation of solvents. Moreover, the clean gas temperature level following afterburning is low, and the clean gas enthalpy can be used to preheat fresh gas fed to the plant. The low clean gas temperature is fundamentally due to the design or construction of the device for exhaust air purification and is therefore essentially not a feature of the actual solvent combustion system.

For the plant according to examples disclosed herein, an electric and therefore flamelessly operated, regenerative-thermal single-bed exhaust air purification system (RTO), which achieves a high energy efficiency, is preferred for the exhaust air purification device.

The flow through the electrically heated bed is subjected to open-loop and/or closed-loop control with the aid of disk valves and is switched over cyclically. During flow through the bed, preheating takes place as far as the core; during this process, chemical conversion takes place without the supply of a combustion gas but with the supply of electric energy. The gas then cools on the other half of the bed.

As soon as the system reaches the operating temperature, it is often only the heat energy released by the oxidation of solvents that is required to achieve self-sustaining and autothermal operation (from about 1 g of solvent per m³ of air); electric heating or additional heating is not required in this operational case. The high efficiency of this device is apparent from the fact that the outlet temperature of the clean gas is only 20 K above the inlet temperature of the exhaust air to be purified.

As already discussed above, it is worthwhile to exploit the clean gas enthalpy for fresh gas preheating with the aid of a heat exchanger if the exhaust air purification device is close to the treatment plant.

In this case, the already preheated fresh gas flow need only be brought to the final or setpoint temperature of the inlet or outlet lock of the treatment chamber, e.g. with the aid of an additional downstream heat exchanger, such as a thermal oil-gas heat exchanger, which is coupled to the heat carrier circuit.

In another embodiment of examples disclosed herein, provision can be made for a fan for delivering the exhaust air to be arranged in the exhaust gas duct.

In another embodiment of examples disclosed herein, provision can be made for the one or more heating circuits each to comprise at least one heating feed and at least one heating return, and wherein heating gas can be passed into the at least one treatment chamber and out of the at least one treatment chamber by means of the heating circuit.

Accordingly, the heating circuit either carries heating gas directly into the treatment chamber or it serves, by way of the air circulation modules, to heat the gas flow carried in each of said modules by means of a heat carrier medium, e.g. thermal oil.

In another embodiment of examples disclosed herein, provision can be made for at least one pump device, in particular a fan, to be arranged in the heating feed and/or in the heating return, by means of which pump device the heating gas or a heat carrier medium can be delivered in the heating circuit.

In another embodiment of examples disclosed herein, provision can be made for the heating device to be arranged in a manner spatially separated from the treatment chamber, preferably in the open air or in a well-ventilated room or building section.

This is preferable especially if the heat energy generated by the heating device is provided primarily by a hydrogen-based heating boiler or a hydrogen-based heater unit.

In another embodiment of examples disclosed herein, provision can be made for the heat carrier system to be designed as a compact unit, into which at least the heating device, the central heat exchanger and the heat carrier circuit are integrated.

Furthermore, it is also possible for the pump device to be integrated into the compact unit.

It is furthermore advantageous if the heat source of the heating device is or comprises an electric heating element, in particular an AC medium-voltage heating element.

If AC medium voltage (1 to 35 kV) is used, a liquid heat carrier medium must flow around the heating element in order to ensure removal of the heat at elevated temperatures and to avoid temperature hotspots. The same applies analogously to other voltage ranges.

When using a heat carrier system designed as a compact unit too, the heat carrier circuit and the heating gas circuit are coupled to one another via the central heat exchanger for heat transfer.

In another embodiment of examples disclosed herein, provision can be made for the treatment chamber to have an inlet lock and/or an outlet lock, and wherein fresh gas can be fed to the inlet lock and/or the outlet lock via a fresh gas feed line.

By feeding fresh gas into the locks, it is possible there to form in each case a fresh gas silhouette by means of which the atmosphere of the treatment chamber can be separated from the surrounding atmosphere.

In another embodiment of examples disclosed herein, provision can be made for at least one fresh gas module to be arranged in the fresh gas feed line, by means of which module the fresh gas fed in can be temperature-controlled, in particular warmed up.

Warming up the fresh gas is necessary in order to prevent condensation in the region of the locks, which could otherwise impair the treatment of workpieces in the treatment chamber.

In another embodiment of examples disclosed herein, provision can be made for a first fresh gas module, by means of which at least some of the heat energy of the clean gas can be transferred to the fresh gas, to be arranged in the fresh gas feed line, and for a second fresh gas module, by means of which the fresh gas can be warmed up to a setpoint temperature, to be arranged downstream of the first fresh gas module.

In another embodiment of examples disclosed herein, provision can be made for the second fresh gas module to comprise an electric heating element and/or to be coupled to the heat carrier circuit.

Since treatment plants such as drying plants for vehicle bodies are generally equipped with an exhaust air purification device, it is advantageous to use the waste heat from the purification process by using the purified hot clean gas enthalpy flow for fresh gas or fresh air preheating with the aid of a heat exchanger.

In such a case, the fresh air flow is already preheated and must only be brought to the final or setpoint temperature for the inlet and/or outlet lock in a second step or in a second stage.

The use of the waste heat or the heat energy contained in the purified clean gas is appropriate especially when the drying plant and the exhaust air purification device are not set up too far away from one another.

If the drying plant and the exhaust air purification device are set up too far away from one another (if, for example, the exhaust air purification system is outside the building and/or on some other plant level), preheating of the fresh gas is economically not justifiable. In order to bring the fresh gas or, as a rule, the fresh air from the initial temperature, such as a shop temperature of 20° C., to the setpoint temperature, only a fresh gas module with a heat exchanger coupled to the heat carrier circuit, or an electric heating element contained in the fresh gas module, is used to warm up the fresh gas as a single preheating or warm-up stage.

In another embodiment of examples disclosed herein, provision can be made for a fan for delivering the fresh gas to be arranged in the fresh gas feed line.

In another embodiment of examples disclosed herein, provision can be made for each air circulation module to be assigned at least one open-loop and/or closed-loop control device, in particular a 3-way control valve, for open-loop and/or closed-loop control of the temperature of the gas flows carried by the air circulation modules, wherein the open-loop and/or closed-loop control devices are preferably arranged in the feed of the heat carrier circuit and/or in the heating gas feed of the heating gas circuit.

By means of the open-loop and/or closed-loop control device, the air circulation modules and, where applicable, the fresh gas module concerned are thus supplied with the required thermal oil quantity or—in the case of a central heat exchanger—the air circulation modules are supplied with the required quantity of heating gas, wherein the controlled variable in this case is the temperature of the circulating air in the treatment chamber or the treatment chamber sections.

In the case of a centralized heating system with a heat carrier circuit, the heat exchanger of each treatment chamber section or each zone is designed according to whichever of the operating or warm-up case involves the greater heat output. By means of the open-loop and/or closed-loop control devices or control groups, the centralized, relatively constant, electric heat output of the heating device can then be distributed between the treatment chamber sections in accordance with the operating mode, wherein it must be taken into account that the necessary heat output in the operating and the warm-up case differ considerably from one another.

Provision can furthermore be made likewise for each treatment chamber section to be assigned at least one open-loop and/or closed-loop control device, by means of which the respective volume flow of the heating gas returned to the central heat exchanger can be subjected to open-loop and/or closed-loop control.

The object of examples disclosed herein is furthermore achieved by a method for treating workpieces.

The method is used to treat workpieces, in particular to dry vehicle bodies.

The method comprises the following steps:
flow of a plurality of gas flows carried in separate circuits through a plurality of treatment chamber sections of one or more treatment chambers of a treatment plant, wherein the gas flows are carried by separate air circulation modules, which are each assigned to one treatment chamber section;
heating of the gas flows by means of a heat carrier circuit of a heat carrier system, which comprises a heating device, wherein provision can optionally be made for the heat energy contained in the heat carrier medium of the heat carrier circuit
a) to be transferred to the gas flows via heat exchangers of the air circulation modules; and/or
b) to be transferred via a central heat exchanger to one or more heating circuits, in particular heating gas circuits, by means of which heating gas is mixed into the gas flows via the air circulation modules.

In another embodiment of examples disclosed herein, provision can be made for the heating device to have
i) at least one exchangeable heat source; and/or
ii) at least two different heat sources for heating of the heat carrier medium in parallel and/or in alternation.

The method preferably has individual or several of the features and/or advantages described in connection with the air circulation system. The air circulation system furthermore has individual or several of the features and/or advantages described in connection with the method.

Further preferred features and/or advantages of examples disclosed herein form the subject matter of the following description and the graphical illustration of exemplary embodiments.

### BRIEF DESCRIPTION OF THE DRAWINGS

FIG. 1 shows a schematic illustration of a first embodiment of a treatment plant;

FIG. 2 shows a schematic illustration of a second embodiment of a treatment plant;

FIG. 3 shows a schematic illustration of a third embodiment of a treatment plant;

FIG. 4 shows a schematic illustration of a fourth embodiment of a treatment plant;

FIG. 5 shows a schematic illustration of a fifth embodiment of a treatment plant; and

FIG. 6 shows a schematic illustration of a sixth embodiment of a treatment plant.

Elements which are identical or have the same effect functionally are provided with the same reference signs in all the figures.

### DETAILED DESCRIPTION OF THE DRAWINGS

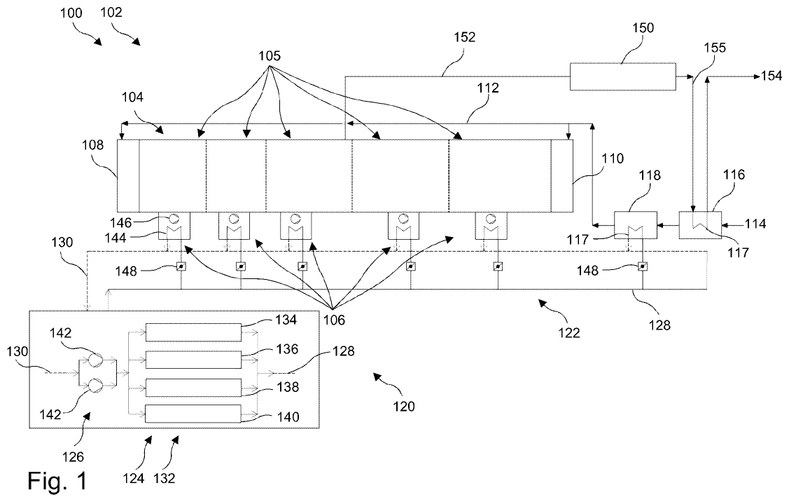

A first embodiment of a treatment plant designated 100 as a whole, which is illustrated in FIG. 1, is used to treat workpieces (not illustrated).

The treatment plant 100 is, in particular, a drying plant 102 for drying previously coated or painted vehicle bodies.

The treatment plant 100 comprises a treatment chamber 104, preferably with a plurality of treatment chamber sections 105.

The treatment chamber sections 105 are preferably each assigned an air circulation module 106.

The treatment chamber 104 furthermore comprises an inlet lock 108 and an outlet lock 110, which are each supplied via a fresh gas feed line 112 with fresh gas 114, in particular fresh air, to form a fresh gas silhouette.

The fresh gas silhouettes in the inlet and outlet of the treatment chamber 104 serve to separate the atmosphere within the treatment chamber 104 from the surroundings.

A first fresh gas module 116 and, upstream of the latter, a second fresh gas module 118, which each have a heat exchanger 117, are arranged in the fresh gas feed line 112. By means of the first and the second fresh gas module 116, 118, the fresh gas 114 drawn in or fed in can be preheated in two stages in order, in particular, to avoid condensation in the inlet and outlet locks 108, 110.

The treatment plant furthermore comprises a heat carrier system 120, which has a closed heat carrier circuit 122, a heating device 124 and a pump device 126.

The heat carrier circuit 122, which has a feed 128 and a return 130, preferably carries a liquid heat carrier medium, e.g. a thermal oil, water or an ionic liquid, in a circuit. As a heat carrier medium, there is a preference for a thermal oil, ideally with a feed temperature of 250° C. and a return temperature of 230° C.

The heating device 124 has at least one, preferably at least two, different heat sources 132, wherein the heat source 132 is designed as
a) an electric heating element 134, and/or
b) a gas-fired heating boiler 136, and/or
c) a hydrogen-fired heating boiler 138, and/or
d) a solar-thermal additional heater 140.

Either each heat source 132 of the heating device 124 is exchangeable or the heating device 124 provides at least two different heat sources 132 for hybrid heating of the heat carrier medium. This ensures that the operator of the treatment plant 100 can react to changes in the energy market in respect, for example, of availability or price.

The pumping device 126, which is preferably arranged in the return 130 of the heat carrier circuit 122, comprises two pumps 142, in particular two circulating pumps, by means of which the heat carrier medium is delivered through the heat carrier circuit 122, in particular in controlled forced circulation. In particular, the two pumps 142 are arranged in parallel.

The heating device 124 furthermore comprises an expansion tank (not illustrated), which is connected via an expansion line (not illustrated) that cannot be shut off to the one or more heat sources 132, thereby enabling the heat carrier medium to expand. In the expansion tank, nitrogen blanketing ensures the required pressure compensation and sealing with respect to a supply of oxygen, thus avoiding oxidation of thermal oil in the case of thermal oil as the heat carrier medium.

The heating device 124 furthermore preferably comprises an open-loop and/or closed-loop control group (not illustrated), by means of which the circulation in the heat carrier circuit 122 can be subjected to open-loop and/or closed-loop control.

The heat carrier medium heated in the heating device 124 is carried to the air circulation modules 106 and the second fresh gas module 118 via the feed 128 of the heat carrier circuit 122.

Each air circulation module 106 has a heat exchanger 144, in particular an oil-air heat exchanger, and a circulating fan 146, in particular a fan, wherein a gas flow is carried in a circuit through the associated treatment chamber section 105 by means of the circulating fan 146.

The heat exchangers 128 of the air circulation modules 106 transfer at least some of the heat energy of the heat carrier medium fed in via the feed 128 to the gas flow of the respective treatment chamber section 105.

In a similar way, some of the heat energy is also transferred from the heat carrier medium in the feed 128 to the fresh gas 114 in the second fresh gas module 118 with the aid of the corresponding heat exchanger 117.

The heat carrier medium cooled by heat transfer is returned from the air circulation modules 106 or the second fresh gas module 118, via the return 130 of the heat carrier circuit 122, to the heating device 124 in order to be heated up again there.

Each air circulation module 106 as well as the second fresh gas module 118 are assigned a respective open-loop and/or closed-loop control device 148, in particular a 3-way control valve, which is arranged upstream of the respective air circulation module 106 and the second fresh gas module 118 in the feed 128 of the heat carrier circuit 122.

By means of the control devices 148, the temperature of the gas flow circulated by each of the air circulation modules 106 in the associated treatment chamber section 105, and the temperature of the fresh gas 114 passed through the second fresh gas module 118, can be subjected to open-loop and/or closed-loop control.

The treatment plant 100 furthermore comprises an exhaust air purification device 150, in particular an electric-thermal exhaust air purification system. An exhaust air purification system designed as a catalytic afterburning system is particularly preferred.

The exhaust air purification device 150 purifies at least some of the exhaust air of the treatment chamber 104 which is fed to it via an exhaust air duct 152, wherein the exhaust air duct 152 is preferably discharged at one of the central treatment chamber sections 105.

A clean gas 154 is discharged as the purified exhaust air from the exhaust air purification device 150 via a clean gas duct 155. The clean gas duct passes through the heat exchanger 117 of the first fresh gas module 117 and, in the heat exchanger 117 of the first fresh gas module 116, transfers at least some of the heat energy contained in the clean gas to the fresh gas 114 fed to the treatment plant 100.

Finally, the cooled clean gas 154 is discharged from the treatment plant 100 at rooftop level.

The embodiments described below preferably have individual or several of the features and/or advantages described in connection with the first embodiment, and vice versa.

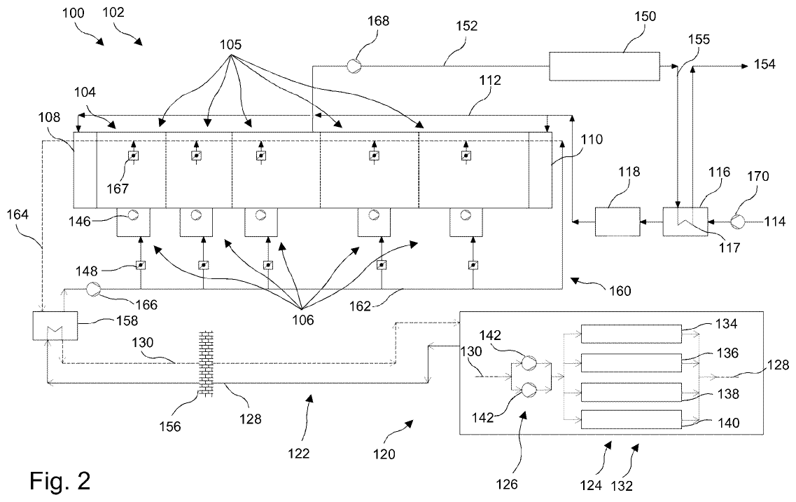

FIG. 2 schematically illustrates a second embodiment of the treatment plant 100 according to examples disclosed herein.

In the second embodiment, the heating device 124 is preferably hydrogen-fired, i.e. the heat carrier medium, which is preferably liquid, is primarily heated by the hydrogen-fired heating boiler 138.

For reasons of safety, the recommendation in the case of a hydrogen-fired heating device 124 is to arrange said heater outside the building boundary 156 of the treatment plant 100, e.g. in the open air or in a separate and well-ventilated building section of the treatment plant 100.

The spatial separation between the heat carrier system 120 and the treatment chamber 104 entails that the heat transfer from the heat carrier medium to the treatment chamber 104 or into the treatment chamber sections 105 should be designed differently in order to avoid losing some of the heat energy temporarily stored in the heat carrier medium along the feed 128 or feed line.

For this reason, the heat carrier circuit 122 is coupled via a central heat exchanger 158 to a heating circuit 160, which is designed as a heating gas circuit. The heating circuit 160 has a heating feed 162 starting from the central heat exchanger 158 and a heating return 164 back to the central heat exchanger 158.

In the central heat exchanger 158, heat energy is transferred from the heat carrier medium carried in the heat carrier circuit 122 to the heating gas circulated in the heating circuit 160 and is carried via the heating feed 162 of the heating circuit 160 to the air circulation modules 106.

A fan 166 is arranged in the heating feed 162 of the heating circuit 160, in particular directly downstream of the central heat exchanger 158.

Air circulation modules 106 in the second embodiment of the treatment plant 100 do not have a dedicated heat exchanger since they are supplied with the already heated heating gas, which is then mixed into the gas flow circulated in the respective treatment chamber section 105. For admixture, the air circulation modules 106 can each have at least one admixture flap (not illustrated).

In the case of the second embodiment in FIG. 2 too, each air circulation module 106 in the heating feed 162 is assigned an open-loop and/or closed-loop control device 148, by means of which the temperature of the gas flow circulated by the corresponding air circulation module 106 can be subjected to open-loop and/or closed-loop control.

Via the heating circuit 164, which is preferably designed as a return duct within the treatment chamber 104 and, as a particular preference, as a triangular duct in the ceiling area and extends along the entire treatment chamber 104, the heating gas is returned to the central heat exchanger 158. There, heat energy is once again transferred from the heat carrier circuit 122 to the heating gas.

Each treatment chamber section 105 can be assigned an open-loop and/or closed-loop control device 167, by means of which the respective volume flow of the heating gas returned to the heating return 164 can be subjected to open-loop and/or closed-loop control.

In comparison with the first embodiment in FIG. 1, it is possible, as an alternative or in addition, to arrange a fan 168 in the exhaust air duct and a fan 170 at the inlet of the fresh gas feed line 112, these fans delivering the respectively carried gas flow in the direction of the exhaust air purification device 150 and of the first fresh gas module 116, respectively.

Accordingly, in one alternative, the second stage of the fresh gas warm-up system, i.e. the second fresh gas module 118, is coupled to the heat carrier circuit 122. In this case, the second fresh gas module 118 has a heat exchanger 117. Alternatively, the second fresh gas module 118 is not coupled to the heat carrier circuit 122 and, instead of the heat exchanger 117, comprises an electric heating element, by means of which the fresh gas is likewise heated to the setpoint temperature for the inlet and/or outlet lock 108, 110.

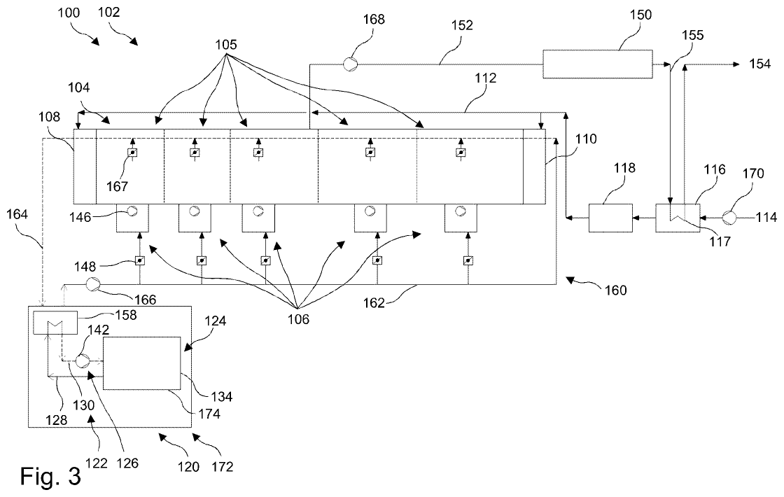

FIG. 3 schematically illustrates a third embodiment of the treatment plant 100 according to examples disclosed herein.

In direct comparison with the second embodiment, the heat carrier system 120, which is preferably arranged or set up within the building boundaries of the treatment chamber 104, is designed as a compact unit 172.

The compact unit 172 comprises the central heat exchanger 158, which is coupled to the heating circuit 160, the heat carrier circuit 122, the pump device 126, which comprises or is just one pump 142 on account of the shortened feed and return 128, 130, and the heating device 124, which is or comprises an electric heating element 134, in particular an AC medium-voltage heating element 174.

A compact unit 172 of this kind can be arranged in the treatment plant 100 in such a way that short line paths for the heating circuit 160 can be achieved. If, in addition, the AC medium-voltage heating element 174 can be operated directly at the medium voltage level of the works network or plant network, there is no need for a transformer load-center substation.

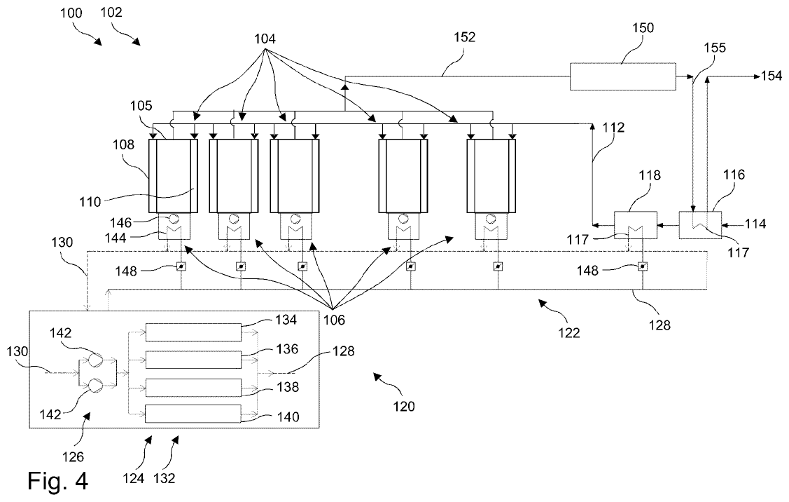

The fourth embodiment of the treatment plant 100 according to examples disclosed herein, which is illustrated in FIG. 4 differs from the first embodiment in FIG. 1 in that, instead of a treatment chamber 104 with a plurality of treatment chamber sections 105, the treatment plant 100 comprises a plurality of separate treatment chambers 104, which each have an inlet lock 108, an outlet lock 110, and just one treatment chamber section 105 for treating workpieces.

Each treatment chamber 104 is assigned an air circulation module 106.

A fresh air silhouette for atmospheric separation of the respective treatment chamber sections 105 from the surroundings can be formed in the inlet and/or the outlet locks 108, 110. As an alternative or in addition, however, it is also conceivable for the inlet and/or outlet lock 108, 110 to comprise a closure element, such as a gate, or to be designed as such.

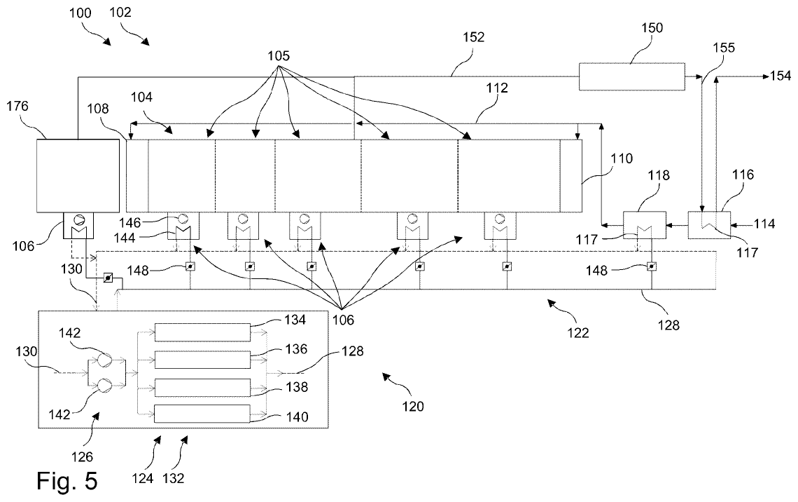

The fifth embodiment of the treatment plant 100 according to examples disclosed herein, which is illustrated in FIG. 5, differs from the first embodiment in FIG. 1 in that, in respect of the delivery direction, which is preferably from left to right in FIGS. 1 to 5, a predrying chamber 176, in which the workpieces undergo prior treatment, such as a predrying process, is arranged upstream of the treatment chamber 104. It is thereby possible, to influence, in particular to reduce, the temperature level in the treatment chamber sections 105 of the treatment chamber 104, for example.

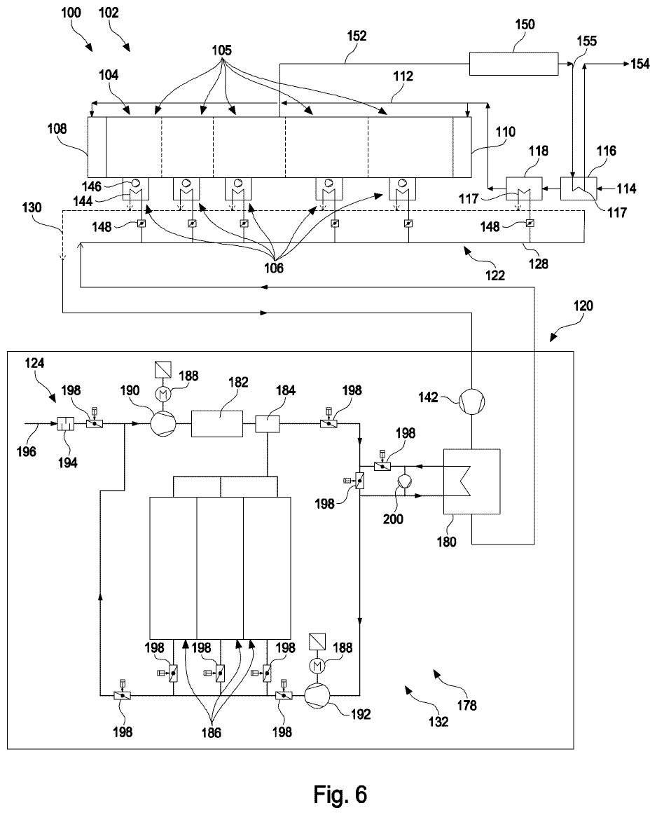

In FIG. 6, the heat source 132 of the heating device 124 is a heating gas circuit 178, wherein the heat of the heating gas carried in the heating gas circuit 178 can be transferred to the heat carrier circuit 122 by means of a heat exchanger 180.

The heating gas circuit 178 preferably comprises an electric heating device 182, a mixing device 184, and at least one, preferably three heat storage units 186, which together form a heat storage device.

The heating gas circuit 178 furthermore preferably comprises a first and a second blower compressor 190, 192, which are driven by a motor 188 and deliver the heating gas flow in the heating gas circuit 178.

In addition, the heating gas circuit preferably comprises a silencer unit 194, which reduces the noise emissions as the fresh air 196 is fed into the heating gas circuit 178.

Apart from this, the heating gas circuit 178 preferably comprises nine open-loop and/or closed-loop control valves 198 for open-loop and/or closed-loop control of the heating gas flow in the heating gas circuit 178.

In normal operation, the heating gas circuit 178 is supplied with fresh air 196, which passes at the inlet through the silencer unit 194 for noise emission reduction.

The volume flow of the fresh air supply is subjected to open-loop and/or closed-loop control by means of a valve 198, which is arranged downstream of the silencer 194 and is preferably subjected to open-loop and/or closed-loop control by means of a piston.

The fresh air fed in is delivered by means of the first blower compressor 190 in the direction of the electric heating device 182, in which the fresh air 196 fed in is heated.

Arranged downstream of the electric heating device 182 is the mixing device 184, which, in normal operation, directs the gas heated in the electric heating device 182, i.e. the heating gas, according to its switching position.

The mixing device 184 preferably has at least three switching positions.

In the first switching state, the heating gas fed in from the electric heating device 182 is directed exclusively in the direction of the heat exchanger 180 arranged downstream of the mixing device 184.

In the second switching state, the heating gas is directed exclusively in the direction of the heat storage units 186 for storage of the heat.

And in the third switching position, the heating gas coming from the electric heating device 182 is directed in the direction of the heat exchanger 180 with the addition of the heat stored in the heat storage units 186.

In normal operation, the mixing device 184 directs the heating gas in its first switching position through a downstream valve 198 in the direction of the heat exchanger 180, wherein this valve 198 subjects the volume flow of the heating gas to closed-loop and/or open-loop control.

In what is referred to as normal operation, therefore, no heating gas is directed into the heat storage units 186 for storage.

The heat exchanger 180 is assigned two valves 198, which direct the heating gas through the heat exchanger 180 or past the latter.

The heat exchanger 180 is also assigned a pump 200, which circulates the heating gas coming via the mixing device 184 through the heat exchanger 180.

The gas flow downstream of the heat exchanger 180 is then delivered by means of the second blower compressor 192 in the direction of the electric heating device 184 for reheating.

Arranged downstream of the second blower compressor 192 there are preferably two open-loop and/or closed-loop control valves 198, which subject the volume flow in the direction of the electric heating device 182 to open-loop and/or closed-loop control.

In the case where heat is added to the heat storage units 186, the mixing device 184 directs the generated heating gas into these in its second switching position, wherein three parallel heat storage units 186, to which heat is added in parallel, are illustrated in FIG. 6.

However, it is also conceivable for heat to be fed into just one heat storage unit 186 or into just some of the heat storage units 186, for which purpose additional valves can be provided between the mixing device 184 and the heat storage units 186.

During the storage process, the valves 198 assigned to the respective heat storage unit 186, which are arranged downstream of the respective heat storage units 186, are at least partially open in order preferentially to enable the residual gas in the heat storage units 186, which is preferably at a lower temperature than the heating gas fed in and which is displaced by the heating gas fed in, to flow into the heating gas circuit 178.

At the end of the heat storage process, the valves 198 assigned to the heat storage units 186 are closed, and the mixing device 184 is preferably switched to its first switching position.

In full load operation, in which it is necessary, for example, to bring the heat exchanger 180 to the required operating temperature within a very short period of time, the mixing device 184 is switched to its third switching position in order, preferably temporarily, to add the heat stored in the heat storage units 186 to the heating gas heated in the electric heating device 182.

Preferably as soon as the required operating temperature has been reached, the mixing device 184 switches back to its first switching position, as a result of which no further heat is released from the heat storage units 186.

In any stoppage times or intervals or at times when the price of power is low, heat can then once again preferably be added to the heat storage units 186 in order, for example, to keep these ready for full load operation.

### LIST OF REFERENCE SIGNS

100 treatment plant
102 drying plant
104 treatment chamber
105 treatment chamber section
106 air circulation module
108 inlet lock
110 outlet lock
112 fresh gas feed line
114 fresh gas
116 first fresh gas module
117 heat exchanger
118 second fresh gas module
120 heat carrier system
122 heat carrier circuit
124 heating device
126 pump device
128 feed
130 return
132 heat source
134 electric heating element
136 gas-fired heating boiler
138 hydrogen-fired heating boiler
140 solar-thermal additional heater
142 pumps
144 heat exchanger
146 circulating fan
148 open-loop and/or closed-loop control device
150 exhaust air purification device
152 exhaust air duct
154 clean gas
155 clean gas duct
156 building boundary
158 central heat exchanger
160 heating circuit
162 heating feed
164 heating return
166 fan
167 open-loop and/or closed-loop control device
168 fan
170 fan
172 compact unit
174 AC medium-voltage heating element
176 predrying chamber
178 heating circuit
180 heat exchanger
182 electric heating device
184 mixing device
186 heat storage unit
188 motor for blower compressor
190 first blower compressor
192 second blower compressor
194 silencer unit
196 fresh air
198 open-loop and/or closed-loop control valve
200 pump

1. A treatment plant for treating workpieces, optionally a drying plant for drying vehicle bodies, the treatment plant comprising:
at least one treatment chamber, which comprises one or more treatment chamber sections, wherein the at least one treatment chamber and/or the one or more treatment chamber sections are each assigned to one of a plurality of separate air circulation modules, and wherein each air circulation module is arranged to carry a separate cyclical gas flow; and
a heat carrier system for indirectly heating the gas flows, which comprises a heating device,
wherein
a) at least one air circulation module has a heat exchanger, by which the respective air circulation module is coupled to the heat carrier system; and/or
b) a plurality of air circulation modules is incorporated into one or more heating circuits, optionally heating gas circuits, which are coupled to the heat carrier system via a central heat exchanger.

2. The treatment plant as claimed in claim 1, wherein the heat carrier system includes:
a closed heat carrier circuit, which has at least one feed and at least one return and in which a liquid heat carrier medium, optionally thermal oil, water or ionic liquid, circulates.

3. The treatment plant as claimed in claim 1, wherein the heating device includes at least one, preferably at least two, different heat sources, wherein the heat source is designed as:
a) an electric heating element,
b) a gas-fired heating boiler,
c) a hydrogen-fired heating boiler,
d) a solar-thermal additional heater, and/or
e) a heating gas circuit.

4. The treatment plant as claimed in claim 3, wherein
a) the at least one heat source is exchangeable with another heat source; and/or
b) at least two different heat sources can be operated in parallel and/or in alternation.

5. The treatment plant as claimed in claim 3, wherein the heating gas circuit, the heat of which can be transferred to the heat carrier circuit by at least one heat exchanger, includes:
at least one electric heating device for heating the heating gas,
at least one mixing device, which is arranged downstream of the at least one electric heating device, and
at least one heat storage unit for storing and releasing heat, wherein the at least one heat storage unit is fluidically operatively connected to the at least one mixing device.

6. The treatment plant as claimed in claim 1, wherein the heat carrier system includes a pump device comprising including at least one pump for delivering the heat carrier medium through the heat carrier circuit and at least part of the heating device.

7. The treatment plant as claimed in claim 1, wherein the treatment plant includes an exhaust gas purification device, in particular, optionally an electric-thermal exhaust gas purification device, for purifying exhaust air, which can be fed from the treatment chamber, via an exhaust gas duct, to the exhaust gas purification device, wherein the exhaust gas purification device carries clean gas obtained by purification out of the treatment plant via a clean gas duct.

8. The treatment plant as claimed in claim 1, wherein the one or more heating circuits each include at least one heating feed and at least one heating return, and wherein heating gas can be passed into the at least one treatment chamber and out of the at least one treatment chamber by the one or more heating circuits.

9. The treatment plant as claimed in claim 8, wherein at least one pump device, in particular optionally a fan, is arranged in the heating feed and/or in the heating return, by which pump device the heating gas or a heat carrier medium can be delivered in the heating circuit.

10. The treatment plant as claimed in claim 1, wherein the heating device is arranged in a manner spatially separated from the treatment chamber, preferably in the open air or in a well-ventilated room or building section.

11. The treatment plant as claimed in claim 6, wherein the heat carrier system is designed as a compact unit, into which at least the heating device, the central heat exchanger and the heat carrier circuit are integrated.

12. The treatment plant as claimed in claim 11, wherein the heat source of the heating device is or comprises an electric heating element, optionally an AC medium-voltage heating element.

13. The treatment plant as claimed in claim 1, wherein the treatment chamber has an inlet lock and/or an outlet lock, and wherein fresh gas can be fed to the inlet lock and/or the outlet lock via a fresh gas feed line.

14. The treatment plant as claimed in claim 13, wherein at least one fresh gas module is arranged in the fresh gas feed line, by which module the fresh gas fed in can be temperature-controlled, optionally warmed up.

15. The treatment plant as claimed in claim 14, wherein a first fresh gas module, by which at least some of the heat energy of the clean gas can be transferred to the fresh gas, is arranged in the fresh gas feed line, and wherein a second fresh gas module, by which the fresh gas can be warmed up to a setpoint temperature, is arranged downstream of the first fresh gas module.

16. The treatment plant as claimed in claim 15, wherein the second fresh gas module includes an electric heating element and/or is coupled to the heat carrier circuit.

17. The treatment plant as claimed in claim 2, wherein each air circulation module is assigned at least one open-loop and/or closed-loop control device, optionally a 3-way control valve, for open-loop and/or closed-loop control of the temperature of the gas flows carried by the air circulation modules, wherein the open-loop and/or closed-loop control devices are preferably arranged in the feed of the heat carrier circuit and/or in the heating feed of the heating circuit.

18. A method for treating workpieces, in particular optionally for drying vehicle bodies, wherein the method comprising:
flow of a plurality of gas flows carried in separate circuits through a plurality of treatment chamber sections of one or more treatment chambers of a treatment plant, wherein the gas flows are carried by separate air circulation modules, which are each assigned to one treatment chamber section;
heating the gas flows by a heat carrier circuit of a heat carrier system, which includes a heating device, wherein the heat energy contained in the heat carrier medium of the heat carrier circuit
a) is transferred to the gas flows via heat exchangers of the air circulation modules; and/or
b) is transferred via a central heat exchanger to one or more heating circuits, optionally heating gas circuits, by which heating gas is mixed into the gas flows via the air circulation modules.

19. The method as claimed in claim 18, wherein the heating device has
i) at least one exchangeable heat source; and/or
ii) at least two different heat sources for heating of the heat carrier medium in parallel and/or in alternation.
